(19) United States
(12) Patent Application Publication
(10) Pub. No.: US 2004/0239782 A1
(43) Pub. Date: Dec. 2, 2004

(54) System and method for efficient improvement of image quality in cameras

(76) Inventors: William Equitz, Waban, MA (US); David R. King, Norfolk, MA (US); David Negro, Brighton, MA (US); David Michael, Wayland, MA (US)

Correspondence Address: ARTHUR J. O'DEA, LEGAL DEPARTMENT, COGNEX CORPORATION, ONE VISION DRIVE, NATICK, MA, 01760-2077, US

(21) Appl. No.: 10/448,790

(22) Filed: May 30, 2003

(51) Int. Cl. H04N 9/64; H01L 27/00

(52) U.S. Cl. 348/246; 348/229.1; 250/208.1

(57) ABSTRACT

A system and method is provided for efficiently correcting and/or normalizing individual pixel outputs in a sensor array, or another set of image data exhibiting fixed pattern noise, by classing various correction factors into a fixed set of classes and identifying each of the pixels in the array based upon its class. Most classes are used to define specific correction conditions (typically discrete gain/offset values), while some classes are set aside for certain bad pixel conditions. Pixels falling within a certain set of predefined gain/offset ranges that are largely similar, but possibly discrete for each other within an acceptable value range, are assigned to a given class during manufacture and this information is stored within a table in the camera's processor. When data is output from the pixels during runtime, the outputting pixel's given class is identified and the appropriate class-based gain/offset is applied to the output to normalize it as it is transmitted downstream to an image acquisition system (PC memory and/or view screen). When a given class indicates a bad pixel of a certain type (e.g. single bad pixel, bad pixel with right-side adjacent bad pixel, bad pixel with adjacent left-side bad pixel, etc.), the appropriate replacement procedure, using, for example an interpolation based upon neighboring pixels, is applied to generate an acceptable output for the bad pixel.

### FIELD OF THE INVENTION

This invention relates to imaging systems, such as digital cameras and more particularly to generation of a more-uniform pixel output from such imaging systems.

### BACKGROUND OF THE INVENTION

Digital cameras, capable of acquiring still and moving images are used in a wide variety of applications. These cameras rely upon a sensor element that is subdivided into a large array of pixels (often more than one million pixels) that resolve a focused light image from the camera lens into a planar image that is received by the sensor. The image is broken (digitized) into individual pixels in the sensor array, and data from each pixel is transmitted to an image acquisition system, such as a personal computer (PC) memory and/or view screen, where the image data is stored and/or viewed. Each pixel data consists of a numerical value (for example, 0-255), that represents a discrete grayscale or color value.

All sensors tend to exhibit some degree of non-uniform response and noise. That is, certain pixels transmit values that do not conform to the average transmission characteristics of the array. They may be too dark, too light or may exhibit another kind of non-uniform response. Likewise, certain pixels may be “bad” in that they always transmit a light or dark output without regard to the characteristic of the actual sensed light. Some sensors, including most commercially available charge-coupled device (CCD) sensors, exhibit fairly good uniformity, and thus correction may only involve correction of the entire pixel array along with basic filtering techniques that do not implicate individual pixels in the array. These CCD sensors tend to be somewhat costly, however, and do not always lend themselves to a variety of compact form factors.

A desirable sensor in terms of low cost and compact form factor is the relatively new, commercially available complementary metal oxide semiconductor (CMOS) sensor element. CMOS sensors are less expensive than CCD models and more compact. These sensors are thus ideal for many industrial applications where a low profile and inexpensive package is desired. Such applications include industrial machine vision where sensors transmit data to a machine vision system that may perform pattern-detection and part-alignment functions. To ensure reliability in the operation of the machine vision system, a relatively clean image is needed.

However, currently available CMOS sensors tend to exhibit a higher variance in pixel-to-pixel noise and non-uniformity of response than CCDs. In particular, these sensors exhibit a higher incidence of fixed pattern noise—non-uniform pixel response that maintains a fixed characteristic and is, thus, predictable. For example, some pixels may always be darker or lighter than their neighbors, regardless of received light level. Like-wise, such pixels may exhibit a gray level that is offset by a certain numerical value relative to neighbors. Where these responses are predictable, they may be compensated-for by applying a correction factor to the non-uniform pixels.

Some filter implementations apply spatial median filtering to filter or cancel isolated pixel faults. However, these filters may also remove useful detail from the image. In other implementations, pixels are measured for performance and individual correction values are stored in memory along with the pixel's position in the array. Briefly, this correction information may consist of gain/offset values for the pixel (versus a desired uniform value) or an average of surrounding pixels. In this implementation every pixel is mapped to a table in memory to determine what, if any, correction, must be applied. This technique may slow the output speed of the image and requires a large amount of memory. For example, if two bytes are stored for every pixel, then the storage must be at least two megabytes for a one-megapixel sensor array. Some implementations may allow for a smaller number of correction factors. For example, where a sensor uses a single amplifier for an entire pixel row or column, the noise often repeats on a column or row basis. A correction factor for each individual row or column may, thus, be employed. However, this solution does not adequately compensate for variations in output between pixels in the same row or column, as all pixels in that row or column are adjusted equally. Likewise, this technique does not take into account bad pixels within a given row or column, which remain bad regardless of the applied correction factor.

Currently available CMOS sensors may employ large-scale integration that connects an individual amplifier to each and every pixel. As such, the average output of every pixel may be quite different from that of its neighbors. Thus, an efficient system and method that accurately compensates for variations between individual pixels in a large sensor array is highly desirable.

### SUMMARY OF THE INVENTION

This invention overcomes the disadvantages of the prior art by providing a system and method for efficiently normalizing or correcting (calibrating) individual pixel outputs in a sensor array, or another set of image data exhibiting fixed pattern noise, by classing various correction factors into a fixed set of classes and identifying each of the pixels in the array based upon its class. Most classes are used to define specific correction conditions (typically discrete gain/offset values), while some classes are set aside for certain bad pixel conditions. Pixels falling within a certain set of predefined gain/offset ranges that are largely similar, but possibly discrete from each other, are assigned to a given class during manufacture and this information is stored within a table in the camera's processor. When data is output from the pixels during runtime, the outputting pixel's given class is identified and the appropriate class-based gain/offset is applied to the output to normalize it as it is transmitted downstream to an image acquisition system (PC memory and/or view screen). When a given class indicates a bad pixel of a certain type (e.g. single bad pixel, bad pixel with right-side adjacent bad pixel, bad pixel with adjacent left-side bad pixel, etc.), the appropriate bad-pixel-replacement procedure, using an interpolation based upon neighboring pixels, is applied to generate an acceptable output for the bad pixel.

In an illustrative embodiment, the class-indexed gain/offset can be one of several class-indexed gain/offset tables stored in the camera memory. Each table is generated at manufacture by measuring array performance under differing operating conditions/settings (e.g. exposure, light level, etc.). At runtime, when the camera is initialized, the appropriate table is retrieved, based upon the input of appropriate operating conditions. This table, customized to the prevailing operating conditions is then used to correct or normalize raw sensor pixel data. As conditions are changed, new tables can be loaded and used, as appropriate.

### BRIEF DESCRIPTION OF THE DRAWINGS

The invention description below refers to the accompanying drawings, of which:

FIG. 1 is a schematic diagram of an exemplary machine vision system application for a camera having pixel correction in accordance with an illustrative embodiment of this invention;

FIG. 2 is a schematic diagram of an exemplary partial pixel array output showing non-uniform pixels and defective pixels;

FIG. 3 is a block diagram of a camera, employing pixel correction in accordance with an illustrative embodiment of this invention;

FIG. 4 is a block diagram of the CMOS sensor control and correction functional block for the exemplary camera of FIG. 3;

FIG. 5 is a flow diagram of an exemplary procedure for determining and classifying defective and non-uniform-response pixels for generation of correction parameters to be used subsequently by the camera;

FIG. 6 is a graphical representation of a group of non-uniform pixels clustered into a predetermined number of classes, in which each of the classes is assigned a discrete, predetermined set of correction parameters;

FIG. 7 is a block diagram of an exemplary pixel correction circuit including correction logic that functions in accordance with an illustrative embodiment of this invention;

FIG. 8 is a flow diagram of an illustrative procedure for runtime correction and calibration of non-uniform and defective pixels in accordance with an illustrative embodiment of this invention; and

FIG. 9 is a block diagram of an exemplary pixel correction circuit including correction logic according to an alternate embodiment.

### DETAILED DESCRIPTION OF AN ILLUSTRATIVE EMBODIMENT

A. Exemplary System Environment

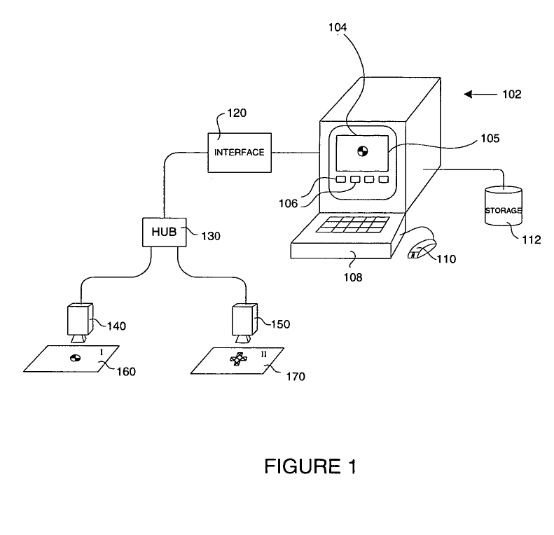

FIG. 1 shows an environment in which the principles of the present invention can be employed. More particularly, a machine vision system 100 is detailed. The system 100 includes a data acquisition and manipulation device—in this case, a personal computer (PC) 102 having an imaging device 104 that allows an image 105 to be displayed and that can include various links and buttons 106 applicable to a graphical user interface for acquiring and manipulating image data. Likewise a keyboard, 108 and mouse 110 are provided. In addition, data storage (a hard disk, electro-optical storage, etc.) 112 is provided to store acquired and manipulated image data as well as vision system application programs and an operating system.

The computer 102 includes a network interface 120 that can either utilize a conventional networking protocol, such as Transport Control Protocol/Internet Protocol (TCP/IP) or Universal Serial Bus (USB), or a dedicated protocol, such as described in U.S. patent application Ser. No. 09/851,534, entitled HIGH-PERFORMANCE DIGITAL SERIAL INTERFACE FOR MACHINE VISION SYSTEMS, by David R. King, the teachings of which are expressly incorporated herein by reference. In accordance with this specialized protocol, the cameras 140, 150 each connect to the interface 120, either directly or through an optional hub or repeater. This arrangement allows multiple cameras 140 and 150 (for example), each viewing a separate image 160 and 170, respectively to be selectively acquired by the system. Each camera is configured according to the teachings of this invention so that the individual pixels output from each camera's sensor is corrected to attain a high-quality output image. Note that is corrected to attain a high-quality output image. Note that this arrangement is only exemplary, and that any application for the camera is contemplated.

The camera of this example can include a complementary metal oxide semiconductor (CMOS) sensor with a separate amplifier stage for each individual pixel output. One such commercially available camera element is the IBIS5-1300 available from Fill-Factory NV of Belgium. This CMOS camera sensor is characterized by a 1280×1024 pixel resolution and a 30 Hz frame rate. Note, however, that the teachings of this invention can be applied to any acceptable imaging device (cameras, scanners, previously stored image data, etc.) that outputs individual pixel data requiring efficient correction.

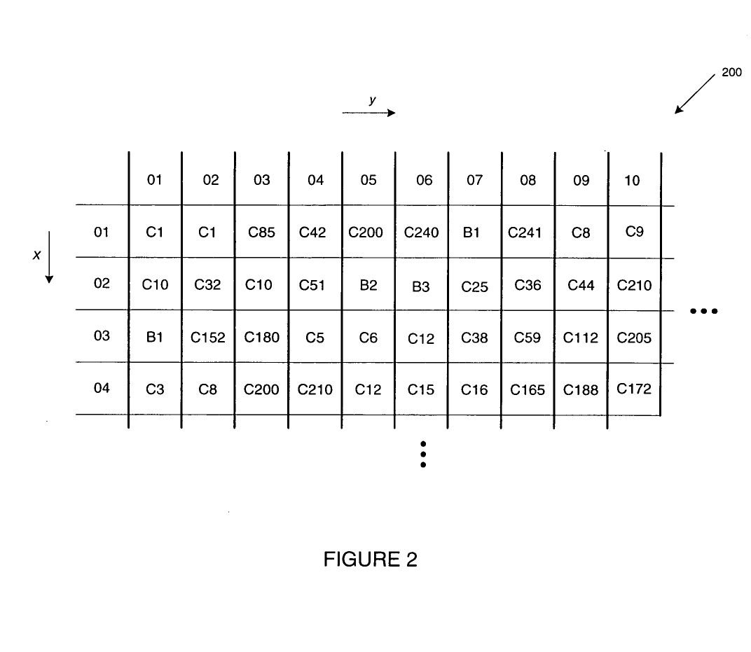

FIG. 2 shows a typical partial pixel output 200 of a sensor in which each pixel is identified by a corresponding row (x) and column (y) coordinate pair. In this partial display, rows 01-04 are shown and columns 01-10 are shown. In fact there can be over one thousand rows and columns of pixels in a conventional display. Each pixel exhibits a unique characteristic response to a viewed uniform image (for example, an overall dark screen or overall light screen). These responses, for reasons discussed further below, are generally characterized by an identifier—C1 for pixel (01,01), C3 for pixel (04,01), C152 for pixel (03,02), etc. These identifiers represent differing responses to the same image input. In addition, certain pixels are identified by a specific defective pixel “class” B1, B2 or B3—namely the single defective or “bad” pixel denoted as B1 (01,07); the left hand bad pixel of a pair denoted as B2 (02,05), and the right hand bad pixel of a pair denoted as B3 (02,06). These so-called “bad” pixels either do not respond to input, remaining permanently stuck in a given output level, or are so skewed from the desired output level as to be unreliable or meaningless. Clearly, where such non-uniformity exists, the generated output may not provide the needed level of image quality for demanding applications such as machine vision.

B. Exemplary Camera Configuration

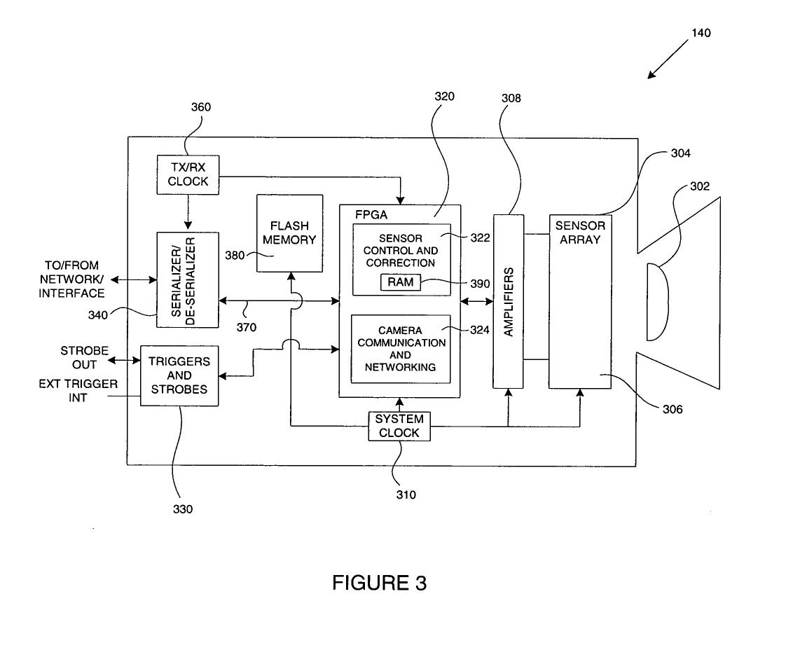

The exemplary camera 140 having pixel correction hardware and/or software in accordance with an embodiment of this invention is shown in further detail in FIG. 3. The camera includes a lens assembly 302 that focuses an image on a sensor 304 that can comprise a CMOS sensor in this embodiment. However, a variety of sensors can be employed in accordance with this invention. The sensor includes a light-sensitive pixel array 306 that receives the focused image from the lens 302. The image is digitized into separate pixels that are each individually amplified by an amplifier stage 308. In operation, the sensor typically undergoes an integration phase followed by an image readout phase. Pixels are read out serially under operation of the system clock 310. In this example, it is a 38-MHz clock that governs the imaging and image processing functions of the camera. The read-out pixel data is in raw, uncorrected form as it exits the amplifier stage 308, and may include significant bad pixel data and fixed pattern noise similar to the output shown in FIG. 2. This uncorrected data is transmitted to a Field Programmable Gate Array (FPGA) 320, which is a highly integrated custom processor that includes a sensor control and correction functional block 322. This block is responsible for applying appropriate correction to each of the read-out pixels to obtain a desired high-quality image. The correction block's function is described in detail below. In addition, the FPGA contains a camera communication and networking block 324 that is responsible for packetizing and depacketizing data for transmission across the network in the applicable protocol. This communication block 324 is part of the overall interface described in detail in the above-incorporated HIGH-PERFORMANCE DIGITAL SERIAL INTERFACE FOR MACHINE VISION SYSTEMS patent application. More particularly, this block 324 allows command data (external triggers and strobes 330), as well as image data to be transmitted to and from the camera in accordance with the network protocol. Note, it is expressly contemplated that a different processing mechanism (micro-controller, microprocessor, etc.), and/or a different networking arrangement can be employed.

A deserializer and serializer (block 340) are each provided to translate serial data carried over the network into parallel data employed by the FPGA 320 and vice versa. Corrected image data passes through the link 370 from the FPGA 320 into the serializer for transmission over the network. The serializer and deserializer are each driven by a transmit/receive clock 360 that, in this example operates at 40 MHz. The clock 360 is also interfaced with the FPGA so that the communication block 324 is clocked at an appropriate speed. In addition, a non-volatile memory (a flash memory in this example) 380 is provided for storing various program data including pixel correction tables in accordance with this invention. In this embodiment, the flash 380 contains 32 Mbits of storage organized as 64 blocks with 32K words per block. It supports high-speed synchronous burst reads of data. Pixel correction data is, thus, stored in an address space in the flash that is divided into modulo 1024 word (1280 byte or pixel) segments. This matches the resolution of the exemplary camera. Upon initialization, appropriate table information is transferred from the flash memory 380 and into local RAM 390 associated with the correction block 322 of the FPGA 320. This transfer is described further below.

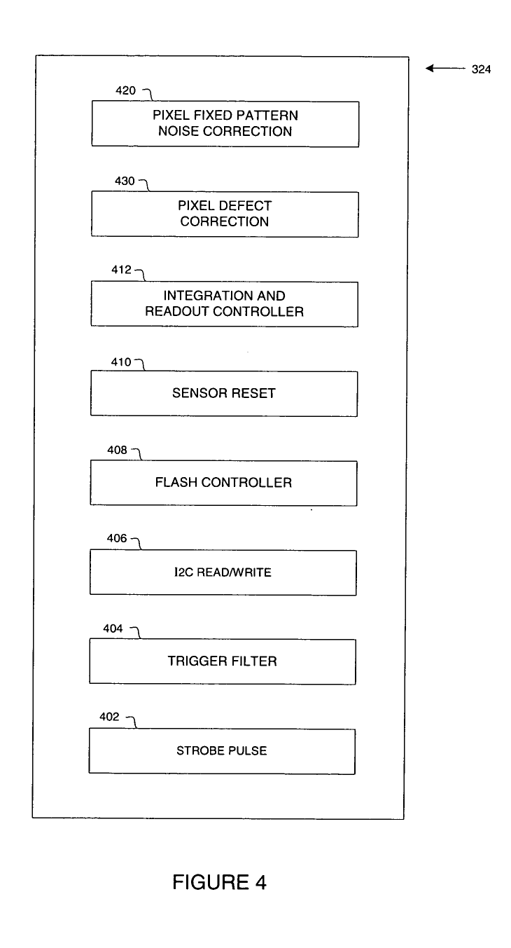

Reference is now made to FIG. 4, which shows exemplary functional blocks within the overall control and correction block 324 of the FPGA 320. These blocks can each comprise a separate state machine and/or programmed function within the FPGA. The functional blocks shown are exemplary only and different or alternate functions can be implemented. The strobe pulse block 402 is responsible for generating a direct illumination signal at the appropriate time. The trigger filter block 404 is responsible for monitoring the camera's trigger input signal. The trigger filter outputs a request for image acquisition by the camera each time a signal is present on the camera's trigger signal line. The signal must be at least a predetermined length in time to be considered valid by the filter and must also occur at least a predetermined delay time after the previous trigger signal. The integration and readout controller block 412 places the CMOS sensor into the integration state in response to an output from the trigger filter 404. The duration of the integration cycle is adjustable to meet the requirements of specific applications. Following the completion of the integration cycle, the CMOS sensor is automatically placed in readout mode and the pixel information is extracted.

The 12C read/write block 406 translates all register write cycles destined for the image sensor from parallel to serial. This is needed in the exemplary camera as it uses a variation of the Inter-IC Communications (12C) protocol for all register based operations. Further, the flash controller block 408 is responsible for interpreting network-based commands and for issuing the appropriate sequence of memory timing during camera programming and initialization. As images are acquired, the block 408 monitors the sensor's parameters which define a current region of interest as well as the timing marks that indicate the completion of the integration cycle or the end of acquisition of a line (row) of pixels. As will be described below, this information is used to calculate the flash memory address and perform burst reads of pixel defect data therefrom. Additionally, the sensor-reset block 410 is responsible for issuing a pulse stream that is interpreted by the camera as an initialization signal. This is used to return the camera to a post-power-on state. Note that each of the above-described blocks may be varied depending upon the specific camera or imaging device implementation.

The control and correction block 324 as shown in FIG. 4 also include functional blocks 420 and 430 that specifically correct pixel fixed pattern noise and pixel defects, respectively. To filter non-fixed pattern noise, several identical images may be taken, and these are averaged to remove evanescent artifacts that do not occur repetitively in each image. Fixed pattern noise correction corrects (or “calibrates”) recurring imbalances or non-uniformity in the overall response of individual pixels to a given light stimulus. The raw output of each non-uniform pixel is gently modified based upon a customized correction parameter set that bring the pixel value reasonably close to a uniform desired value. One possible correction parameter set consists of a gain G, which is a linear slope and an offset O, which is a fixed value. In this example, the basic expression for correction or calibration of a given pixel i by the functional block 420 is

xⁱ_{calibrated}=xⁱ_{uncalibrated}*Gⁱ+Oⁱ.

The functional block 430 deals with defective or “bad” pixels. Briefly, these pixels are either unresponsive to stimulus, or so skewed (typically more than 50 gray levels off) from a desired value as to be unreliable or meaningless. Bad pixels do not give an uncalibrated output value that is useful enough to apply standard offset and gain correction parameters. Rather, bad pixels are replaced with interpolated values based upon values of adjacent neighbor pixels. Given the resolution of the camera (in that any imaged features are represented by at least a few neighboring pixels), the neighbors are assumed to be reasonably close values to the bad pixel. That is, either the bad pixels have roughly identical values to the neighboring pixels or the bad pixels are part of a relatively continuous (predictable) gradient of values across the group of neighboring pixels. Ideally, interpolation is performed using calibrated neighbor pixels, but uncalibrated neighbors can also be employed with reasonable accuracy in most instances. It is most significant that the neighbors from which a bad pixel is interpolated be “good” pixels themselves (as opposed to neighboring bad pixels B2 (02,05) and B3 (02,06) in FIG. 2). Otherwise an inaccurate interpolation occurs. Having briefly described the functional blocks for fixed pattern noise correction and defective or bad pixel correction, the correction process at manufacture and runtime is now described in further detail.

Note, in an alternate embodiment, gain and offset, as a set of correction parameters can be replaced with another set of correction parameters including, but not limited to a correction factor look-up table (LUT) that provides correction indexed to particular deviations from a desired base pixel response. Therefore, the term “correction parameter” should be taken broadly, and should include look-up-table-derived values (among others). The expression in this case, where Correction_LUT is a particular look-up table value would be:

xⁱ_{calibrated}=Correction_{—}LUT*x¹_{uncalibrated}.

This expression provides more general correction flexibility, typically at the cost of more memory per correction table.

C. Creation of Correction Parameters at Manufacture

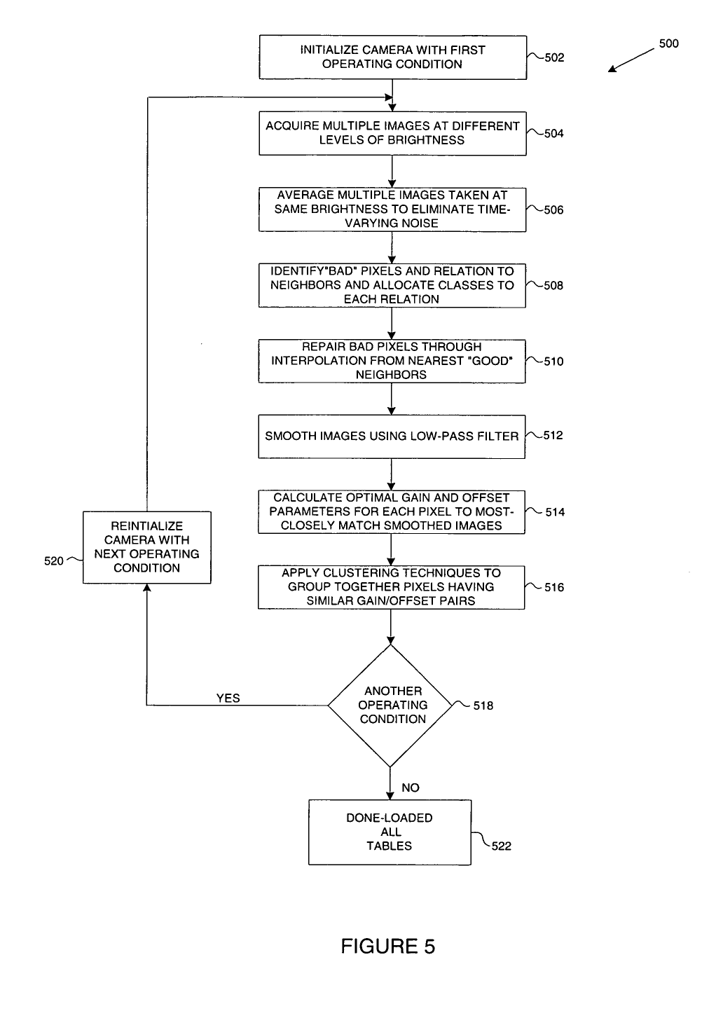

It is contemplated that the camera is provided with all needed correction information in memory prior to distribution to an end user. Reference is made to FIG. 5, which details a basic procedure 500 for determining correction or calibration parameters for use in calibrating the raw pixel output of the camera sensor. This procedure is typically carried out on a manufacturer's test stand in which the camera is fixed, and exposed to a uniform light source (a light panel, for example) capable of outputting varying levels of brightness. The camera is initialized with a first operating condition setting (step 502). The operating condition consists of a variety of user-input variables including exposure, temperature, contrast, etc. Then, the camera is commanded to acquire a number (approximately twenty) of images at each of approximately eight different brightness levels (step 504). The brightnesses are altered so as to acquire images at a wide variety of gray scale values. In this embodiment, brightness is varied by varying the light presented by the light panel.

Given the raw images acquired by the sensor, “averaged” images Xₐᵥ, are created at each brightness level by averaging together a number of images X to eliminate time-varying (non-fixed-pattern) noise, thereby leaving behind only fixed-pattern noise (step 506). Next the procedure identifies any “bad” pixels as being any that are, for example, at least fifty gray values away from the average level for the entire image at any brightness level. Bad pixels that are isolated (have left and right neighbors that are “good”) and bad pixels that are part of group (at least one of their left or right neighbors is also bad) are both noted. A class is allocated for isolated bad pixels, another for the left-hand member of a pair of bad pixels, a third for the right hand member of a pair, etc. (step 508). In general groups of bad pixels are rare and the size of bad-pixel groups supported may be limited. In an illustrative embodiment, typically half dozen classes are reserved specifically for bad pixels.

Next all the bad pixels are repaired via interpolation from the nearest “good” left and right hand neighbors, which may be termed “anchors” (step 510). When correcting an isolated bad pixel, it is replaced with the average of its immediate left and right neighbors, but if it's part of a string of bad pixels, a linear interpolation is accomplished, weighting the nearest left and right anchors based on distance. This repaired image can be termed R(Xₐᵥ). The correction of defective or bad pixels is described in further detail below.

Then, a “smoothed” image from R(Xₐᵥ) is created at each brightness using a smoothing operator S(·), such as a low-pass filter. The smoothed image is employed as the “ground truth,” under the assumption that fixed pattern noise is high-frequency, and any low-frequency variations are due to lighting variations, the camera housing blocking the light path around the edges of the sensor, etc. (step 512). The following relationship applies:

X_{ground truth}=S(R(Xₐᵥ))

It is desirable to “repair” the image prior to smoothing, since bad pixels that are permanently on or off cause the smoothed image to appear “lumpy,” thereby distorting the calibration process.

The next step (step 514) is to calculate the optimal gain and offset parameters for each pixel using the eight different brightness levels, taking the Xₐᵥ image as the “observed” data and the X_{groundtruth} image as the “desired” value. Brightness levels that appear clipped may be discarded because they may distort gain/offset calculations. Thus, sometimes fewer than eight data points, but at least two are used to perform the calculation, and given two-to-eight pairs the optimal gain and offset values for that pixel are computed using the well-known linear least squares method.

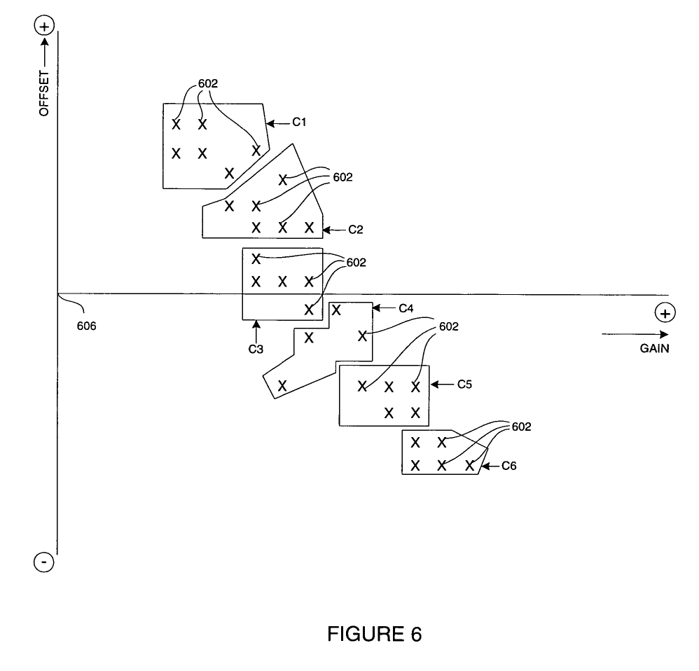

Then, standard clustering techniques are applied to group together pixels that have similar gain/offset pairs (step 516). The number of classes available for gain/offset correction, in the illustrative embodiment is 256, less the number classes reserved for bad pixels. Thus, a clustering technique that allows the choice of the specific number of clusters is used—such as an agglomerative method. FIG. 6 shows an exemplary (partial) graph 600 of clustering of pixels 602 according to gain and offset. The goal of the clustering process is to group pixels 602 together into classes of clusters (C1, C2-C-6 . . . ) of multiple pixels that share relatively similar gain/offset values with respect to the normalized origin 606. In this manner, a fixed and manageable number of cluster classes (significantly less than the total number of pixels) can be established, and all pixels within the given class can be represented by a single, common, averaged gain and offset value. As defined herein, the pixels in a given cluster have “similar” output characteristics in that they are similar enough that an averaged correction parameter will adequately correct them all. The pixels may be identical in value or may be discrete values with respect to each other. In any case, the clustering of similar pixels should result in a single value assigned to all in the cluster (e.g. the class). This single gain and offset value is close enough for all pixels in the cluster/class that a high-quality correction of all pixels in the cluster may be maintained. The class is, thus, assigned a single gain/offset correction value derived from a weighted average of the gain and offset of all clustered pixels in the class, or alternatively, from a center point within the cluster.

Note that two-dimensional (gain, offset) pairs are clustered as two-dimensional vectors, rather than quantizing the gain and offset parameters separately, since the gain and offset values are correlated, and grouping them as pairs allows for much more accurate and efficient classification. The clustering process requires that assumptions be made as to how similar one gain/offset pair is to another, and there are a number of techniques that can be employed to accomplish derive this relationship. However, using standard two-dimensional Euclidean distance with no normalization is less effective because gain typically falls in the range [0.5, 2.0] and offset in the range [−25, +25], meaning that differences in offset may overwhelm any differences in gain. Thus, one approach is to normalize each of the gain and offset values to be in a fixed range (for example, 0 to 1) before performing the clustering, and another is to use some other measure that compares the various lines implied by the given gain/offset pair. At this point each pixel has been classified in one of a small number of “bad pixel” classes, or into one of about 250 “correctable” classes, where all members of the same class share similar gain and offset calibration parameters. In this manner a one-byte set of classes (256) can define all bad and correctable pixel classes—significantly reducing the amount of memory that must be mapped to correct all pixels in the array. Each of the given classes may include a two-byte correction parameter including one byte for gain and one byte for offset. The range of gain in one illustrative embodiment is between approximately 0.0078 and 1.9922, allowing a wide range of slopes to correct an unbcalibrated pixel, while offset is between −127 to +127, this allowing addition to or subtraction from an uncalibrated pixel value. Note that correction parameters using more or less than two bytes are contemplated in alternate embodiments.

Since the number of classes is limited to 256 in this embodiment, the flash memory 380 of the camera can store significantly more correction information in a given memory space than would be possible if discrete per-pixel correction factors were employed. This means that multiple tables of correction parameters, representative of different operating conditions can be stored in memory without requiring an unacceptably large storage space. The procedure 500 can query whether correction of pixels in another operating condition is desired (decision step 518). For example, in the particular case of contrast changes, the curve of uncorrected pixel outputs may vary with respect to that in other operating conditions. Thus the ability to change the set of correction parameters to account for differing contrast settings (among other operating conditions) is desirable. Where correction parameters for further operating conditions are sought, the procedure 500 branches to step 520, and the camera is reinitialized with a new operating condition. The above-described class-generation steps 504, 506, 508, 510, 512, 514 and 516 are repeated in view of the new operating condition. When all operating conditions have been tested, the procedure branches via decision step 518 to the end (step 522). At this time, the flash 380 has been filled with a set of correction parameter tables, each suited to a particular operating condition of concern.

As noted above, particular steps are employed to identify bad pixels and the proper neighbors from which a meaningful value for the bad pixel can be interpolated. To identify “bad” pixels one exemplary technique is as follows:

As described in the above calibration procedure 500 a multiplicity of images are acquired at each of a number of brightnesses, trying to exercise the full range of the sensor (e.g. eliciting gray levels less than fifty as well as those above 200). At each brightness level, the overall image mean μ is calculated, and each pixel in the image is compared to the overall average, noting any pixels that are at least fifty gray levels away from the overall mean. If any pixel is fifty or more gray levels off, at any brightness level, then it in considered defective or bad. Most typically, a bad pixel is permanently on or off, although sometimes it simply exhibits a very weak response. Finally, for every bad pixel, the procedure notes whether it is an isolated defect or if it is part of a string/group of adjacent bad pixels. If the bad pixel part of a string or group of bad pixels, then its position in the sequence is noted and the position is encoded as described below.

In one embodiment, the bad pixel classification scheme explicitly identifies the nearest left and right “good” neighbors in a row, which can then be used as anchors in interpolation.

As described above, the procedure employs the same two correction parameter bytes that are used for recording the calibration gain and offset, respectively, to encode the fact that a class describes a “bad” pixel and also to identify the appropriate anchors for the bad pixel. In one embodiment, the special code for gain (0×80) identifies that this class is for bad pixels and the second byte identifies the location of anchor points around the pixel with which interpolation is undertaken. Note that a class for a particular type of bad pixel need only be reserved if that type of bad pixel actually exists in the raw sensor output. Otherwise any unused bad pixel classes can be used as part of the calibration classes, allowing a finer clustering of pixels within the 256 (for example) total classes.

There are many techniques for encoding the location of the anchors with respect to a given bad pixel. One approach is to divide the spare byte into two 4-bit “nibbles” and to use each nibble to encode how far away to the left and right the anchors should be. In this example, the code “0000” denotes the immediate neighbor, the code “0001” denotes a neighbor two steps away, and so on, whereby the code “1111 ” denotes a neighbor 16 steps away. The most significant nibble identifies the location of the left anchor and the least significant nibble identifies the location of the right anchor. For example, consider the following encodings:

| | |
|---|---|
| single defect: | 0000.0000 (see class B1 in FIG. 2); |
| left of a sequence of two defects: | 0000.0001 (see class B2 in FIG. 2); |
| right of a sequence of two defects: | 0001.0000 (see class B3 in FIG. 2); |
| left of a sequence of three defects: | 0000.0010; |
| center of a sequence of three | 0001.0001; and |
| defects: | |
| right of a sequence of three | 0010.0000. |
| defects: | |

Of course, where a defect occurs at the far left (see pixel (03,01) in FIG. 2) or right edge of a row, the interpolation must be able to account for this, as the preceding or succeeding anchor may be on the previous or next row, on an edge opposite the subject bad pixel. This is described further with respect to runtime where actual interpolation using acquired anchor values occurs.

D. Runtime Pixel Correction

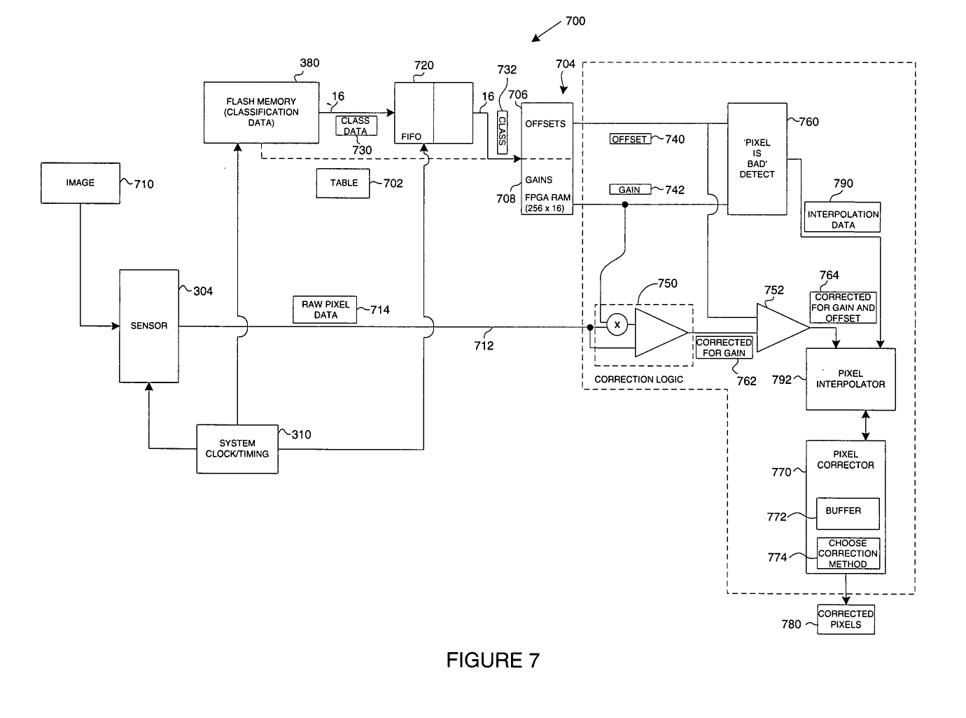

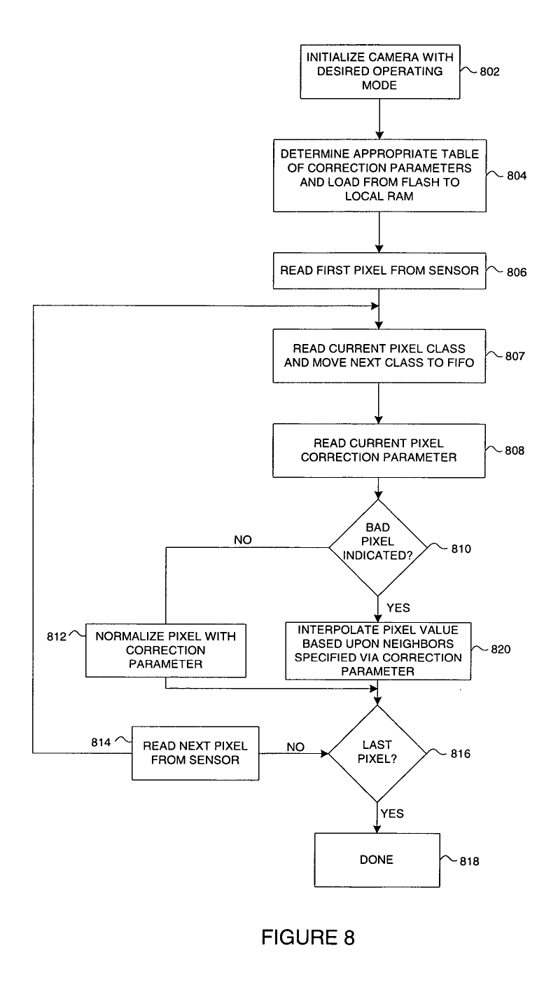

FIG. 7 shows a schematic representation of the pixel correction circuit 700 for use in the exemplary camera of this invention. This circuit is implemented in the FPGA 320 described above. However, it is contemplated that it can be provided in a variety of hardware and software implementations, depending mainly upon the processing speed. For the real-time camera image data provided by the exemplary camera, the illustrated high-speed FPGA provides needed processing speed in performing the calibration or correction procedure. Likewise, FIG. 8 is a flow diagram details the procedure 800 for correcting or calibrating the raw pixel data at camera runtime.

At runtime, the camera is initialized and a desired operating mode, or set of operating conditions, are input (step 802). As described above, these conditions can include a specific exposure setting, contrast setting, temperature setting and other conditions that effect image output quality. The correction procedure then addresses the flash memory (see memory 380 in FIG. 7) and loads the appropriate table 702 of correction parameters (256 classes by two bytes) in a local random access memory (RAM) 704 (step 804). The local RAM contains 256 class entries, each having a byte for offset 706 and a byte for gain 708. As noted above, certain classes are set aside for defective pixels, and these carry information in one byte (typically the gain byte 708) indicating pixel defect and the proper anchors to interpolate in the other byte (offset byte 706).

Once the table 702 is loaded in local RAM 704, the readout and calibration/correction of raw pixel data can begin. In general, the readout of raw pixel data 714 follows integration of the image 710 by the sensor (304 in FIG. 7). Raw pixel data 714 is then transmitted over the output line 712 from the sensor 304 serially, moving from one row to the next until all pixels are read out. This occurs under the control of the system clock (310 in FIG. 7) which synchronizes the sensor, memory 380 and a first-in-first-out (FIFO) buffer 720 described further below. Before the first pixel is transmitted from the sensor the class data 730 for first pixel is transmitted to the FIFO 720 from the flash memory 380, so that the class of the incoming pixel is queued at the local RAM 704. In other words, the applicable class for each pixel is stored in the flash 380 as an entry in a register containing a class for every pixel in the image field, and is passed (class 730) from the flash to the local RAM 704, in conjunction with each clock cycle, in time to meet up with the raw pixel data 714 transmitted from the camera. Proper timing is assured because the per-pixel class data stored in the FIFO 720 is at least one pixel ahead of the raw pixel data 714 that is transmitted from the sensor 304.

In accordance with the correction or calibration procedure 800, as the first raw pixel data is read out (step 806), the local RAM 704 reads the current input class for the pixel (step 807), and correlates the input class for that pixel with the appropriate two-byte correction parameter (step 808) from the stored table of classes-versus-parameters. Note, in accordance with step 807, that after each class is read from the FIFO, the clock shifts another class from an upstream position in the FIFO into a read position so it is ready for reading by the local RAM 704. Likewise, the next pixel class is transmitted to the upstream position in the FIFO, ready to shift to the downstream position at the next clock cycle. In this manner (and due to the relatively fast shift speed of the FIFO), the next class is always queued and ready for presentation to the local RAM in time for arrival of the associated raw pixel data.

A byte of offset correction data 740 and a byte of gain correction data 742, associated with the read class, are transmitted over respective lines from the local RAM 704 to a multiplication unit 750 capable of amplification or attenuation and an adder 752, and to a bad-pixel-detect logic 760. The bad-pixel-detect logic 760 determines if the gain byte has a value indicating a bad pixel (decision step 810). If not, then the raw pixel data is calibrated (normalized) by the multiplier 750 and 752 (step 812). Specifically, the multiplier 750 combines the gain correction parameter 742 with the raw pixel data 712 to generate a pixel corrected for gain 762. The adder 752 then takes this partially corrected value (762) and applies the offset correction parameter 740 to generate the fully normalized pixel 764. The pixel data is passed through an interpolator 792 and a buffer stage (buffer 772 in the corrector function 770). Note that the corrector function 770 decides (using correction choice block 774) whether to use the interpolated pixel value (from the interpolator 792), based upon neighbor pixel value information in the buffer 772, or to use the pixel's own gain and offset-calibrated value 764. Within a few clock cycles the corrected/normalized pixel 780 is read out from the buffer 772 to downstream acquisition devices over the network. The procedure continues, reading each succeeding pixel and the associated class (decision step 816 and steps 814 and 807) until the last pixel of the image is read-out and normalized. At this time the runtime read-out and correction cycle is complete (step 818) until the next image frame is taken, at which time the correction procedure 800 begins again.

If any pixel in the readout is accompanied by a bad pixel class, then the bad-pixel-detect logic 760 produces an output of interpolation data 790 (see decision step 810 and step 820). This interpolation data consists of the chosen anchors (left and right), to be employed by the interpolator 792 in deriving a pixel value. The anchors are typically the closest “good” left and right neighbors. However, in the case of an edge pixel, the anchors may consist of the one or two closest inboard pixels. Note that in this case the “corrected” pixel value output from the multiplier 750 and adder 752 is ignored, as it is a meaningless value, and an interpolated value is substituted in the output buffer. Sufficient neighboring pixel data is stored in the buffer to obtain neighboring anchors for the interpolated pixel. In an illustrative embodiment, two left and two right neighbors (five total including the subject) can be buffered. This allows up to a three-defective-pixel group to be corrected. More or fewer buffered pixels can be provided in alternate embodiments. The following are some particular considerations with interpolation of a single defective pixel, as well as a double and triple grouping of defective pixels:

1. Single Pixel Defects

In this case the correction logic detects the assertion of a CenterBadPixel signal (interpolation data 790) and simply replaces the defective pixel, Pixel(n), with the average of its nearest neighbors, Pixel(n−1) and Pixel(n+1).

Pixel(n)=[Pixel(n−1)+Pixel(n+1)]/2

In an alternate embodiment, this equation can include pre-scaling the two variables and then perform the addition operation. This technique requires a slightly smaller adder but sacrifices a small amount of accuracy if the pre-scaling is performed without any rounding (e.g. 4/2=2 and 5/2=2; 104/2=52 and 105/2=52).

2. Double Pixel Defects

While a generalized solution for interpolation is described above in Section C, the following is a more-detailed and efficient implementation, where two adjacent pixels, Pixel(n), and Pixel(n+1), are both defective. The correction logic recognizes this case by detecting the assertion of LeftBadPixel and RightBadPixel on consecutive clock cycles. A two-step correction process is then be applied wherein the first defect is replaced by the weighted average of Pixel(n−1) and Pixel(n+2). In this step, Pixel(n+2) is weighted by ½ relative to pixel(n−1) since it is two pixels removed from the pixel being corrected.

Pixel(n)=[Pixel(n−1)/2+Pixel(n+2)/4]/(3/4)

Note that this form of the interpolation requires a non-power-of-two division step. This may prove difficult to perform efficiently in an FPGA. However, by using the same pre-scaling technique discussed above, and replacing the division with multiplication, the following alternative form of the interpolation can be expressed as follows:

Pixel(n)=[Pixel(n−1)/2+Pixel(n+2)/4]*1.3333

A further simplification is to approximate the fraction multiplication process using power-of-two scaling combined with a final addition. This two-step process can be expressed as follows:

TempPixel(n)=Pixel(n−1)/2+Pixel(n+2)/4

Pixel(n)=Temp Pixel(n)+[TempPixel(n)/4+(TempPixel(n)/16+TempPixel(n)/64)]

Note that the fraction sum of ¼, 1/16, and 1/64 equals 1.328125 which introduces an estimation error of 0.39% when compared against the desired scale factor of 4/3 or 1.3333.

Once the new value for Pixel(n) has been calculated, the replacement value for Pixel(n+1) is developed using a simple average of the “correct” value for Pixel(n) and Pixel(n+2) using the pre-scaling equation presented above.

3. Triple Pixel Defects

The following provides a more efficient implementation of interpolation (relative to the generalizations in Section C, above) in the somewhat complicated case is where three pixels, Pixel(n−1), Pixel(n), and Pixel(n+1), are all defective. The correction logic recognizes this case by detecting the assertion of LeftBadPixel, CenterBadPixel, and RightBadPixel on consecutive clock cycles. This type of defect entails a three-step correction process. The first step is to generate a new value for the center pixel, Pixel(n), using the weighed average of the closest pixels containing accurate data, Pixel(n−2) and Pixel(n+2). In this step, both pixels are equally weighted by since they are two pixels removed from the pixel being corrected.

ti Pixel(n)=Pixel(n−2)/2+Pixel(n+2)/2

Once this step is complete the new values for remaining two defects, Pixel(n−1) and Pixel(n+1), are estimated using the same averaging technique employed for single pixel defects using the “correct” value for Pixel(n) plus the original values of Pixel(n−2) and Pixel(n+2).

Pixel(n−1)=Pixel(n−2)/2+Pixel(n)/2

Pixel(n+1)=Pixel(n)/2+Pixel(n+2)/2.

The above-described system and method advantageously allows accurate correction of fixed pattern noise and pixel defects in a camera or other imaging device. A number of correction parameter tables to be permanently stored on the camera or other imaging device so that the user need not load calibration data at a future time. Of course a copy of the data can be stored at the manufacturer in the event correction or calibration data must be reloaded, but under normal circumstances, the data follows the camera at all times. Because of the compression of correction parameters into a relatively small number, several tables, each customized to a particular operating condition can be employed. These compressed tables can be quickly retrieved and loaded into the camera's runtime processor. The tables are further customized to the particular camera's performance based upon the correction parameter creation procedure undertaken during manufacture. In this manner, efficient compression of the correction data is maintained, but the data is closely matched to the particular camera's performance profile.

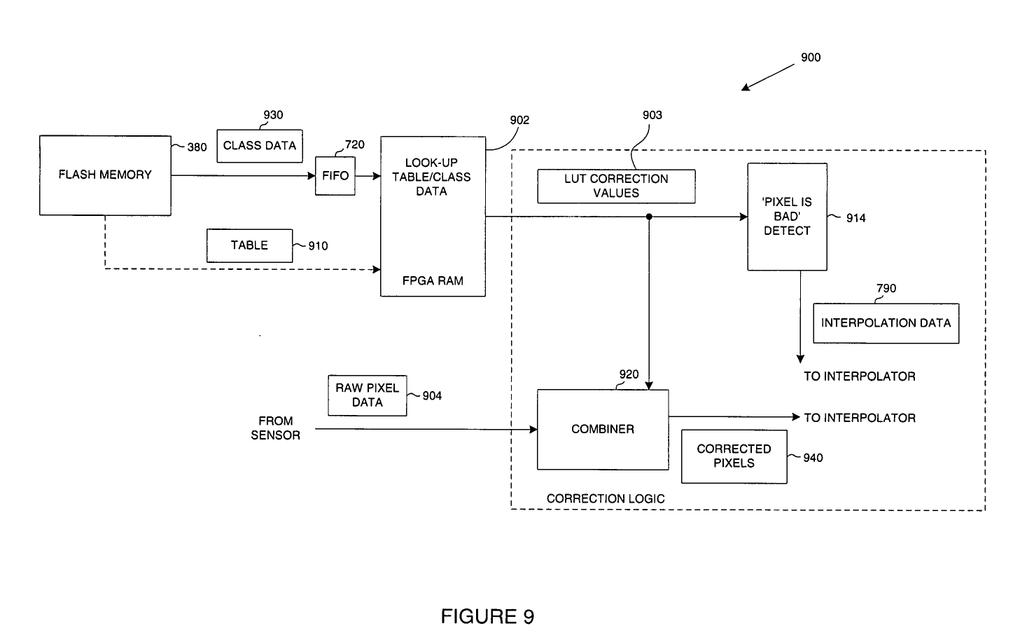

As noted above, the correction logic can use a variety of types of correction parameters, including look-up-table-derived values. FIG. 9 shows a diagram of a partial circuit 900 (other elements not shown functioning similarly to those of FIG. 7) that utilizes look-up table (LUT) values 903 indexed according to classes in the FPGA local RAM address space 902 to correct raw pixel data 904 from the sensor. The classes are loaded as a table 910 from the flash 380 upon initialization, but contain LUT values rather than gain, offset pairs. Certain LUT values can indicate particular defective pixel conditions (e.g. single bad, left neighbor bad pair, right neighbor bad pair) and are recognized by the detect circuit 914 as such. The detect circuit 914 passes interpolation data 790 as described above to the interpolator (shown in FIG. 7). In the case of a non-uniform pixel that is corrected by the LUT correction values 903, the value is passed to a combiner (an adder, for example) 920 that combines the value 903 with the raw pixel data 904 to generated corrected pixels 940 that are passed to the corrector and interpolator described above in FIG. 7. The correction values are generated as classes indexed to each of the pixels in the stream are passes through the FIFO 720 from the flash 380. This final output stage occurs in the manner described generally in FIG. 7.

The foregoing has been a detailed description of embodiments of the invention. Various modifications and additions can be made without departing from the spirit and scope thereof. For example, while the correction and calibration techniques described herein are employed in a CMOS camera, they can be applied to any imaging system (or other “sensor”) in which a pixel (or other “data element”) readout requires efficient correction, including non-real time systems. The principles herein can be implemented as hardware, software that consists of a computer-readable medium executing program instructions, or as a combination of hardware and software. The number and configuration of classes can be widely varied, and the “correction parameters” can be any acceptable factors that provide correction to pixel data and should not be taken to include only gain and offset. Accordingly, this description is meant to be taken only by way of example, and not to otherwise limit the scope of the invention.

What is claimed is:

1. A system for calibrating a group of uncorrected pixel data from a imaging device comprising:
a stored table having a plurality of entries less than a total number of uncorrected pixels in the group, the entries each being one of a set of correction parameters indexed to each of a plurality of classes, and each of the classes being associated with a plurality of pixels in the group having similar uncorrected output characteristics;
a register that associates each of the pixels in the group with one of the classes; and
a correction logic that retrieves one of the correction parameters associated with each one of the classes and that applies the retrieved one of the correction parameters to each of the uncorrected pixels.

2. The system as set forth in claim 1 wherein the correction logic includes pixel-defect detection logic that identifies predetermined classes as indicative of a defective pixel and that signals the correction circuit to replace a value generated by the defective pixel with a value calculated using neighboring pixels.

3. The system as set forth in claim 2 wherein the classes associated with defective pixels include a plurality of identifiers that indicate whether the defective pixel is adjacent to another defective pixel.

4. The system as set forth in claim 1 further comprising a first-in-first-out buffer that receives data on each of the classes from the register associated with each of the pixels and buffers the data for use by the correction logic.

5. The system as set forth in claim 1 wherein the table is associated with a predetermined operating condition of the imaging device and further comprising a plurality of tables each having a plurality of entries less than a total number of uncorrected pixels in the group, the entries each being one of the correction parameters indexed to one of a plurality of classes class, and each of the classes being associated with a plurality of pixels in the group having similar uncorrected output characteristics, wherein each of the plurality of tables is associated with a predetermined operating condition and is provided to the correction logic when the predetermined operating condition is present.

6. The system as set forth in claim 5 wherein each of the tables is constructed by providing the imaging device with an image at a plurality of brightness levels, clustering responses of the pixels relative to a normalized response into groups identified by the classes and assigning one of the correction parameters, respectively, to each of the groups.

7. The system as set forth in claim 6 wherein the responses that exceed a predetermined range with respect to the normalized response are each clustered into a defective pixel class that is one of a plurality of defective pixel classes.

8. The system as set forth in claim 1 wherein the table is constructed by providing the imaging device with an image at a plurality of brightness levels, clustering responses of the pixels relative to a normalized response into groups identified by the classes and assigning one of the correction parameters, respectively, to each of the groups.

9. The system as set forth in claim 8 wherein the responses that exceed a predetermined range with respect to the normalized response are each clustered into a defective pixel class that is one of a plurality of defective pixel classes.

10. The system as set forth in claim 1 wherein the imaging device comprises a CMOS camera sensor.

11. The system as set forth in claim 1 wherein each of the correction parameters comprises both of a gain value and an offset value.

12. The system as set forth in claim 1 wherein each of the correction parameters comprises a look-up-table-derived correction factor.

13. A method for calibrating a group of uncorrected pixel data from a imaging device comprising the steps of:
storing a table having a plurality of entries less than a total number of uncorrected pixels in the group, the entries each being one of a set of correction parameters indexed to each of a plurality of classes, and each of the classes being associated with a plurality of pixels in the group having similar uncorrected output characteristics;
associating each of the pixels in the group with one of the classes; and
retrieving one of the correction parameters associated with each one of the classes and that applies the retrieved one of the correction parameters to each of the uncorrected pixels.

14. The method as set forth in claim 13 wherein the step of retrieving includes identifying predetermined classes as indicative of a defective pixel and that signals the correction circuit to replace a value generated by the defective pixel with a value calculated using neighboring pixels.

15. The method as set forth in claim 14 wherein the classes associated with defective pixels include a plurality of identifiers that indicate whether the defective pixel is adjacent to another defective pixel.

16. The method as set forth in claim 13 further comprising moving identifiers of the classes through a first-in-first-out buffer that receives data from a register of classes associated with each of the pixels and buffers the data for use by the correction logic.

17. The method as set forth in claim 13 wherein the table is associated with a predetermined operating condition of the imaging device and further comprising a plurality of tables each having a plurality of entries less than a total number of uncorrected pixels in the group, the entries each being one of the correction parameters indexed to one of a plurality of classes class, and each of the classes being associated with a plurality of pixels in the group having similar uncorrected output characteristics, wherein each of the plurality of tables is associated with a predetermined operating condition and is provided to the correction logic when the predetermined operating condition is present.

18. The method as set forth in claim 17 wherein each of the tables is constructed by providing the imaging device with an image at a plurality of brightness levels, clustering responses of the pixels relative to a normalized response into groups identified by the classes and assigning one of the correction parameters, respectively, to each of the groups.

19. The method as set forth in claim 18 wherein the responses that exceed a predetermined range with respect to the normalized response are clustered into a defective pixel class.

20. The method as set forth in claim 13 further comprising constructing the table by providing the imaging device with an image at a plurality of brightness levels, clustering responses of the pixels relative to a normalized response into groups identified by the classes and assigning one of the correction parameters, respectively, to each of the groups.

21. The method as set forth in claim 20 further comprising clustering the responses that exceed a predetermined range with respect to the normalized response into a defective pixel class from one of a plurality of defective pixel classes.

22. The method as set forth in claim 13 wherein the imaging device comprises a CMOS camera sensor.

23. The method as set forth in claim 13 wherein each of the correction parameters comprises both of a gain value and an offset value.

24. The method as set forth in claim 13 wherein each of the correction parameters comprises a look-up-table-derived correction factor

25. A method for providing correction parameters associated with each of the pixels of an imaging device for use in correcting a runtime image generated by the imaging device comprising the steps of:
providing a substantially uniform image for acquisition by the imaging device and generating a pixel output having a plurality of pixels with respective values based upon the provided image;
comparing each of the values to a normalized value and determining a numerical distance of each of the values away from the normalized value;
clustering similar ones of the values into each of a plurality of classes having a fixed total number of classes and assigning a single one of a plurality of correction parameters to each of the classes; and
assigning one of the classes to each of the pixels, whereby runtime pixels generated in a runtime image are each associated with one of the classes and are each corrected using the single one of the plurality of correction parameters associated with the one of the classes assigned to each of the runtime pixels.

26. The method as set forth in claim 25 wherein the step of comparing, includes comparing each of the values based upon a gain and an offset with respect to the normalized value.

27. The method as set forth in claim 26 wherein the step of providing includes providing an image at a plurality of brightness levels.

28. The method as set forth in claim 27 further comprising averaging the values from multiple images taken at each of the plurality of brightness levels to reduce time-varying noise.

29. The method as set forth in claim 25 wherein the step of comparing includes identifying defective pixels based upon values that are outside of an expected numerical range of values.

30. The method as set forth in claim 29 further comprising allocating specific defective pixel classes to identified defective pixels based upon presence or absence of neighboring defective pixels with respect to the identified defective pixels.

31. The method as set forth in claim 29 wherein each of the steps of providing, comparing, clustering and assigning are performed for a plurality of different operating conditions for the imaging device and wherein the plurality of correction parameters are grouped into a plurality of stored tables each associated with a respective of the plurality of operating conditions.

32. The method as set forth in claim 31 wherein the imaging device comprises an CMOS camera sensor and each of the tables is stored in a camera flash memory and an assignment of the classes to each of the pixels is also stored in the flash memory.

33. A method for correcting a runtime image in an imaging device comprising the steps of:
transmitting a stream of pixel values comprising an image frame to a correction logic;
reading out a stream of classes associated with each of the pixels, a number of the classes being less than a number of pixels in the stream; and
applying a correction parameter associated with each of the classes, respectively, of a set of correction parameters so as to normalize each of the pixel values in the stream.

34. The method as set forth in claim 33 further comprising determining, based upon each of the classes, whether each of the pixel values is a correctable value using the correction parameters or a defect, and correcting each defect by replacing the defect with a value based upon values of neighbor pixels to the defect.

35. A system for calibrating a group of sensor data from a sensing device comprising:
a stored table having a plurality of entries less than a total number of uncorrected elements in the group, the entries each being one of a set of correction parameters indexed to each of a plurality of classes, and each of the classes being associated with a plurality of elements in the group having similar uncorrected output characteristics;
a register that associates each of the elements in the group with one of the classes; and
a correction logic that retrieves one of the correction parameters associated with each one of the classes and that applies the retrieved one of the correction parameters to each of the uncorrected elements.
